(19) United States
(12) Patent Application Publication
(10) Pub. No.: US 2012/0316993 A1
(43) Pub. Date: Dec. 13, 2012

(54) Method and system for pricing and exchange of streams of data stored on tags readable by electronic means, streams of data in digital messages, and streams of data from electronic devices

(76) Inventor: Stanley Benjamin Smith, Fort Mill, SC (US)

(21) Appl. No.: 13/136,421

(22) Filed: Aug. 1, 2011

Related U.S. Application Data
(63) Continuation-in-part of application No. 13/134,596, filed on Jun. 11, 2011.

(51) Int. Cl. G06Q 30/00

(52) U.S. Cl. 705/26.43

(57) ABSTRACT

The invention provides a method and system to enable buyers and sellers of data items associated with data streams housed on electronically readable data tags or data streams contained within digitally transmissible messages or data streams generated by devices capable of implementing computer readable code to set, manage, and collect fees for the one or a plurality of data items and for the processing, collection, and posting of the one or a plurality of data items. It further provides a method for collection of fees and posting data from data streams to datasets through electronic devices capable of implementing computer readable code. It further provides a method for electronic devices capable of implementing computer readable code to write data into electronic messages or onto electronically readable data tags or to other electronic devices capable of running computer readable code.

### BACKGROUND OF THE INVENTION

1. Field of the Invention

A method and system for pricing and processing sale or exchange of data stored on tags readable by electronic means, streams of data within digital messages, and streams of data from electronic devices capable of implementing computer readable code.

2. Description of the Related Art

Many businesses, such as retail sales operations and shipping and transportation businesses, maintain or track inventories through use of radio frequency identification tags (RFIDs) or other electronically readable data tags. These tags locate and assign attributes and statuses as well as prices to items in their supply chains. This data has seldom been exchanged with potential users of the data external to these enterprises because of a desire to keep certain information proprietary and the absence of a method to offer the data selectively for sale and to price and sell it easily. With advances in miniaturization and computerization, variants of these tags, such as readable and writeable subcutaneous transmitters of medical status information can also offer useful, indeed essential, information for the well-being of persons. The RFID tag is only one instance of a tag readable by an electronic device capable of running computer readable code through wireless transmission or other methods of transmission.

Further, many human beings and businesses are now utilizing short digital strings of computer readable characters and data that Twitter and other Internet capable digital messaging systems are enabling for social communication. Some of these messaging systems can also be applied to communicate about business activities. Users of these messaging services and these messaging services themselves will need to determine values and prices for making the messages and the data streams within these messages available for purposes of research, analysis, transformation, and reuse. The repurposing of data from instant messaging services and from electronically readable data tags and biological information transmitters and from any of the plethora of electronic devices capable of implementing computer readable code requires systems and methods to enable protecting and/or stripping out some subsets of these data streams to maintain confidentiality for some data and facilitate pricing and fees for exchange of other data in data streams designated as saleable or sharable by their owners.

The tendency of enterprises to retain almost all data and information in-house is changing. One enabling factor has been the ability of authentication and security routines that run on electronic devices capable of implementing computer readable code to prevent proprietary information or data that might be used by a competitor from exposure, while exposing only data that the owner of the data would choose to expose. RFID (Radio Frequency Identification) tags or other electronically readable data tags themselves are increasingly sophisticated and are capable of housing drivers and additional computer readable code to enable complex calculations, reading of biological or chemical activity if implanted or proximal to a living entity, implementing data configurations, and even triggering of actions through computer readable code housed within the tags or transmitters. The ability to detect or upload and download data or instructions to other tags or electronic devices or media is now practicable. With the advent of HTML5, API's that used to require separation of web pages from application of computer readable code are obviated and linkages between electronic devices and transmitters and interne messages that may require complex semantic and data management functions are feasible and achievable. Computer readable code for parsing and structuring data streams transported as Internet messages, such as SMS text messages, Twitter messages, or Instant Messaging from Microsoft is currently undergoing development, and a market for exchanging the data within these messages, and tools to structure these streams of data will become increasingly sophisticated and more widely available.

Methods and systems for pricing data streams from electronic devices or segments of data streams within messages like SMS text messages are similar to those needed for electronically readable data tags or transmitters. In both cases, streams of data are being transmitted and processed, and may be designated as available for sale. New art in this invention leverages the potential for conversion of a data stream on an electronically readable data tag or transmitter into multiple message formats for SMS messaging or Twitter or other messaging service providers; and vice versa. This new art is also applied to data streams from any electronic device capable of implementing computer readable code, including computers, smart phones and tablet computing devices.

An additional enabling factor for pricing data streams has been the increasing distribution and ubiquity of electronic devices such as smart phones and tablets or “pads” that can process computer readable code and upload information through wireless means to the Internet and social networking and cloud computing sites and then transfer and restructure data. The transfer of data from these devices to electronically readable data tags or transmitters to messaging vendors and services will enable delivery of data streams to be practical and widespread. The invention described herein advances the evolution of a data economy where any entity might decide which data they own need no longer be kept proprietary and may be exchanged reciprocally or for a fee. A subset of the entire emerging industry of data trading is reflected through this invention's use of electronically readable data tags or transmitters and use of Twitter and Instant messaging and other messaging services to leverage the ability of the Internet and other wireless or hard wired networks of connected devices to transmit data.

Trading data for a fee is not uncommon. Email lists and domain or topic specific datasets held and managed by data warehousing entities have been quite common. However, until the art described in Smith (U.S. Pat. No. 7,860,760), real-time transfer of particular data items based on conditions and configurations established by the original owner of the data was not explicated or protected. The evolution of a data marketplace where data is traded like any commodity is beginning to be practical through use of electronic devices coupled with electronic media and computer readable code. Banks have determined that selling data regarding credit card transactions and associated variables, behavior, and purchasing patterns of their customers might serve as an additional source of revenue. They sell records of credit card purchase data of their customers to multiple competing retailers and manufacturers and other businesses. Data contained on electronically readable data tags associated with products or services within a supply chain coupled with credit card information associated with buyers and sellers of these products and services has potential value to many participants in a marketplace. This data can enable businesses to better target and focus their marketing and logistics planning. Additionally the parsing and organization of streams of data from messaging services, such as Twitter, is becoming a part of the data transactional marketplace. Smith (Ser. No. 13/134,596) of which this patent is a continuation in part, also introduces art for extracting data from devices capable of implementing computer readable code so it may be readily uploaded, priced, bought and sold, transferred, and exchanged.

Ownership of data housed within or transmitted through wireless devices and across the Internet has not been definitively established. As ownership of data gets more clearly defined, mechanisms and systems for operating a data marketplace will evolve to reflect the laws and property rights of the various generators and processors of data. One of the areas in the process of clarification concerns ownership and sale of data collected through point of sale devices that connect data read from electronically readable data tags or transmitters and entered into a credit card reader or other electronic device capable of transmitting credit card data and enabling association of the retailer, the customer using the credit card, the financial institution processing the credit card payment, and many other entities associated with the physical and digital supply chain. Indeed, data streams and subsets of data streams that may be associated with an ownership trail linking buyers to products and vendors of products and financial institutions have not been developed in a robust or systematic fashion.

A similar arrangement of relationships and links will emerge within the health care system, where implanted subcutaneous transmitters or biologically and chemically sensitive implants will transmit medical information to electronic devices or across the Internet or other networks of devices and link to data sources and enable researchers or medical services providers to proactively intervene in real time to improve medical outcomes. Any systems can benefit from this kind of real time information and status access. Another group of data streams is the data contained within SMS text messages or Twitter messages or Instant messages from one of the Internet enabled messaging services. Robust and systematic methods for charging for data items within data streams and for the processing of messages and the processing of the data is not only feasible, but becoming a business necessity.

Systems for transferring payments or fees for data are in their infancy. The need is increasing for systems and methods to capture sort and classify information a retailer, sales outlet, manufacturer, services vendor or consumer determines a need to protect or to permit to be transmitted to specific parties. When product data or other data is input into a point of sale device and coupled with credit card or other financial transaction information related to the buyer or the seller, a price or fee for the data included in the transaction may be charged. Data within messages and messages themselves are chargeable. Phone services and carriers often charge for SMS messaging, but not for the data within the massages or for the processing of the data within the messages. This low level of granularity for fees may soon be insufficient for some purposes, and, if a data economy is to evolve, further granularity may be an aid to the evolution of the data exchange market.

Fees may also be charged for links to systems that transfer and exchange data. Many business entities require these methods and systems. The trading of data of this kind is a “win-win” proposition for all parties because of the increasing efficiencies, and utility of the data if it is exchanged in real time. The right actionable information to the right human being at the right time with sufficient context will increase productivity and improve logistics and project management and other tactical and marketing decisions made by businesses or entities that provide services, such as medical providers. The invention described herein enables buyers and sellers of data to price data from tags readable by electronic means and from messages obtained through messaging services and vendors as it is posted and recorded and exchanged or transferred within a data marketplace. Data transported through messaging services such as Twitter and Microsoft Instant Messenger and other messaging services can be priced for both the data itself and the processing of the data.

RFID tags and other electronically readable data tags store data, sometimes including ePC and other product tagging codes. A problem for consumers of data, such as data aggregators, federators, data warehouses, medical and other researchers, brokers, and resellers results from these data points being disassociated from a method or system for setting or collecting fees for trading them. Connecting data to pricing and systems and methods for data exchange will help this market evolve rapidly and efficiently. Incompatible systems and methods require purchasers or consumers of data to build one-off software applications or middleware to price the data in order to enable it to be exchanged and federated or aggregated into a larger dataset for research, analysis, repurposing, or reuse.

A second problem for buyers and users of streams of data from RFID or other tags or transmitters of message strings or streams of data is the absence of utilities or tools to enable conversion of the stream of data into tabular formats that designate row and column labels for some of the data and strip or delete or leave out other strings of characters or information that offer no value to the user or buyer.

Selling and purchasing data should be as simple and easy as trading any other commodity, but the issues described above create problems for data pricing and exchange. Data with relevance and value for the data purchaser may be as simple as a subset of the string of data items housed within an RFID or other electronically readable data tag or message from a messaging vendor such as Twitter. Methods and systems for processing the subsets or strings of data may require a complex linking of manufacturers, customers, products, vendors of products, financial institutions, data warehousers and federators, data analytic and research engines and middleware applications, as well as time and date and price triggers and other transactional records and events generated through electronic devices capable of implementing computer readable code. The invention contained herein provides methods and systems to achieve these exchanges and to leverage the emerging capabilities of HTML 5 and Python and other scripting languages that can enable API's to be folded into web pages and subsets of web pages as data streams.

### BRIEF SUMMARY OF THE INVENTION

The invention herein facilitates data exchange and data pricing within a data marketplace by enabling a method and system for pricing data and the transfer of data streams contained within RFID and other electronically readable data tags or other data transmitters as well as in messages from Twitter or other electronic messaging services that utilize the Internet or wirelessly linked electronic devices capable of running computer readable code. The invention further invents art to convert data streams within messages or generated within or upon or through devices capable of implementing computer readable code for posting onto electronically readable data tags and to convert data streams read from electronically readable data tags into messages that may be sent though messaging services such as Twitter or read or transferred to electronic devices capable of implementing computer readable code. Data streams from messages and data streams from electronically readable data transmitters or tags are readily convertible from one to another through simple operation of computer readable code housed upon any electronic device that receives or transmits a data stream. The invention further enables actions upon data including payment of fees for the data itself, fees for formatting the data within the data stream for posting into data tables or other formats for processing and query access, membership, activation, convenience and volume fees and adjustments, as well as payment of fees for other processing of the data. The method and system of the invention described herein further enables data to be classified and grouped and subdivided according to multiple variables including variable prices for data items embedded in these data steams and variable fees for data processing and exchange. Protecting the privacy and confidentiality of particular data items is included within the system and method of the invention. A particular value of the invention to the public in medical arenas such as HIV AIDS and Cancer or chronic illnesses such as Diabetes is the facilitation of a marketplace and method for real time status updates regarding the physical status and responses to medications and other interventions being transmitted through subcutaneous or other electronic medical information and data transmitters. Another particular value of the invention is the potential implementation of real time notification and management of information being transmitted or read within RFID or other tags or electronic transmission devices to track the movement of explosives or other materials that may be used by rogue actors or terrorist organizations to threaten the security of a population or nation.

### BRIEF DESCRIPTION OF THE DRAWING

FIG. 1 is a diagram of components and linked operations.

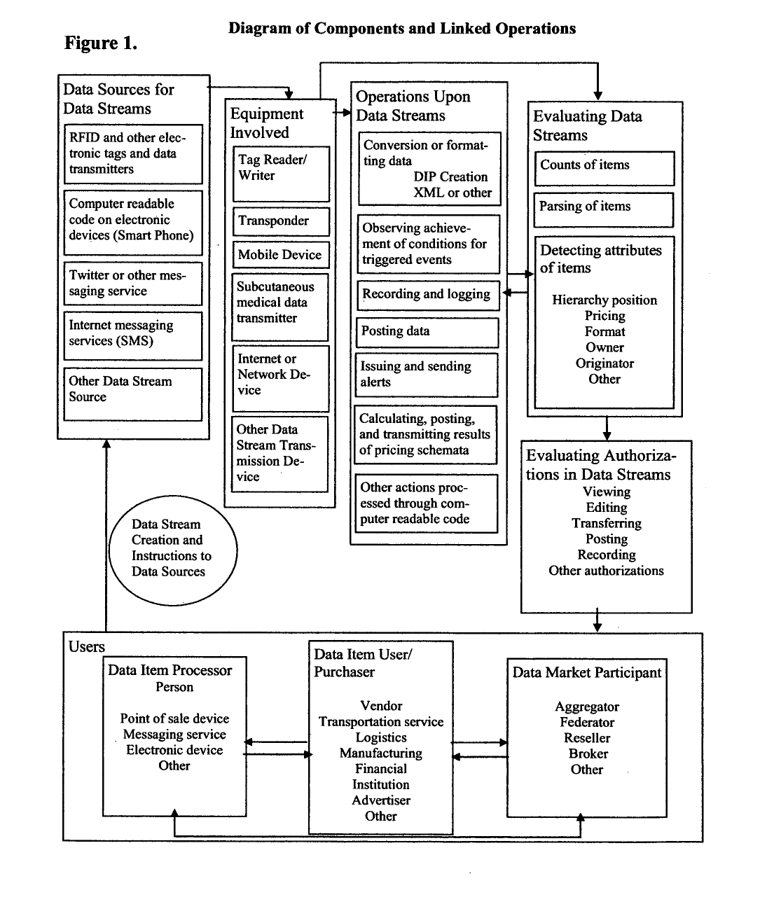

FIG. 2 is a process diagram.

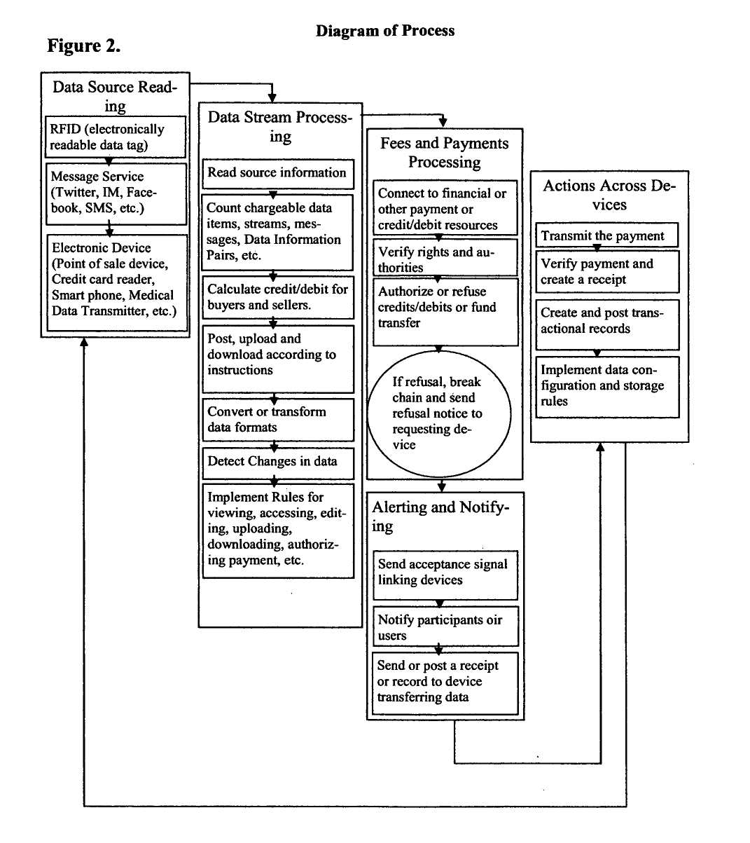

FIG. 3 is a diagram of process relationships of data streams to pricing and posting operations and to devices and other transmitters of data.

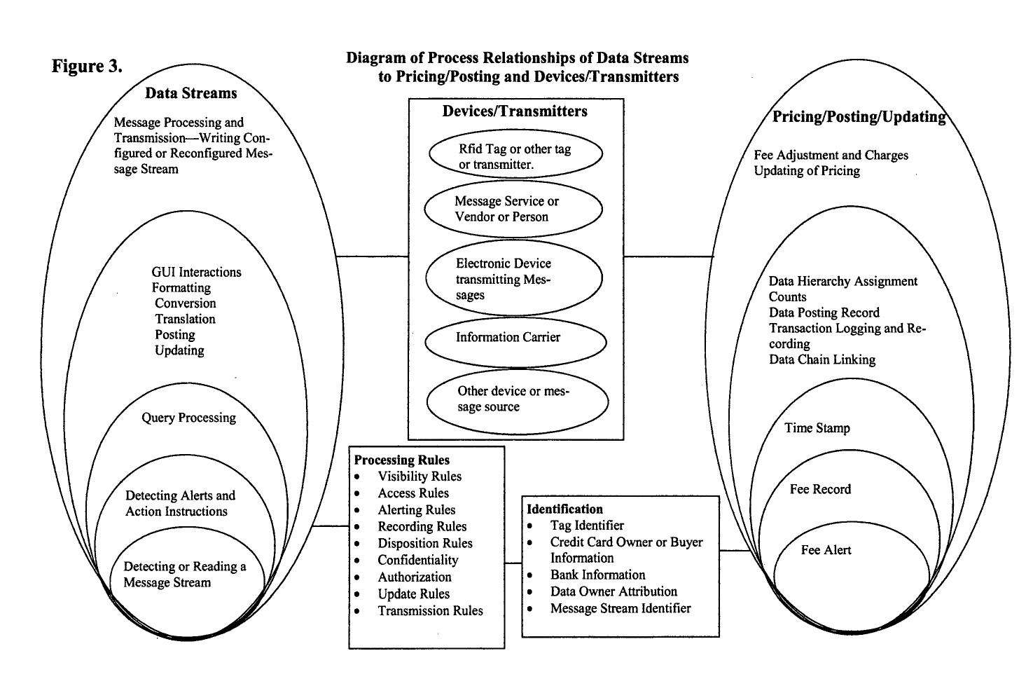

FIG. 4 is a diagram of menu tabs and operations for a utility to convert a data stream into a tabular format for query access.

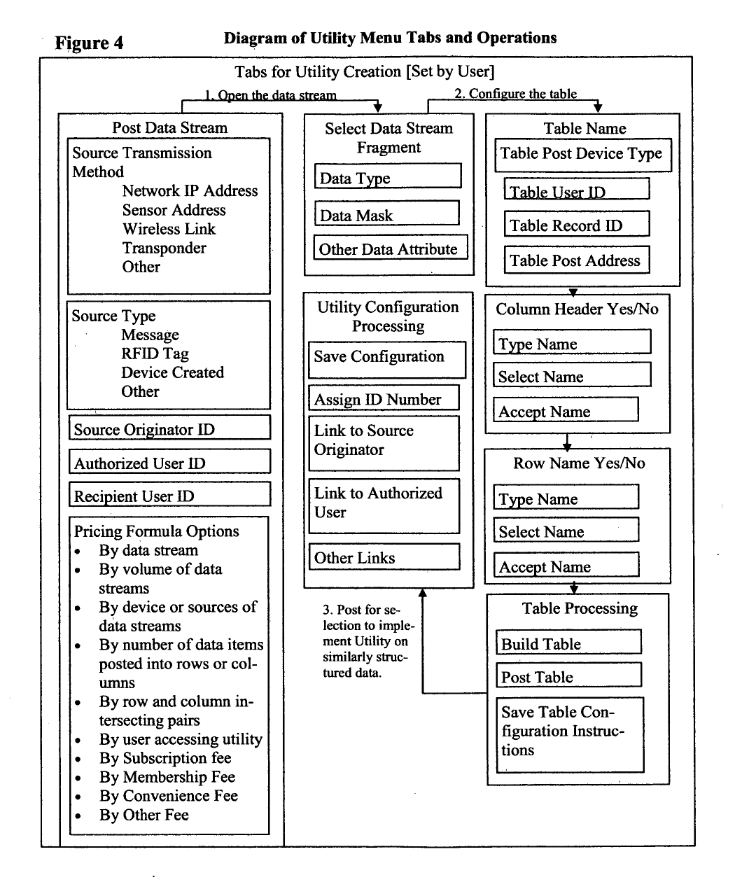

FIG. 5 is a top level schematic of the invention including pricing variables.

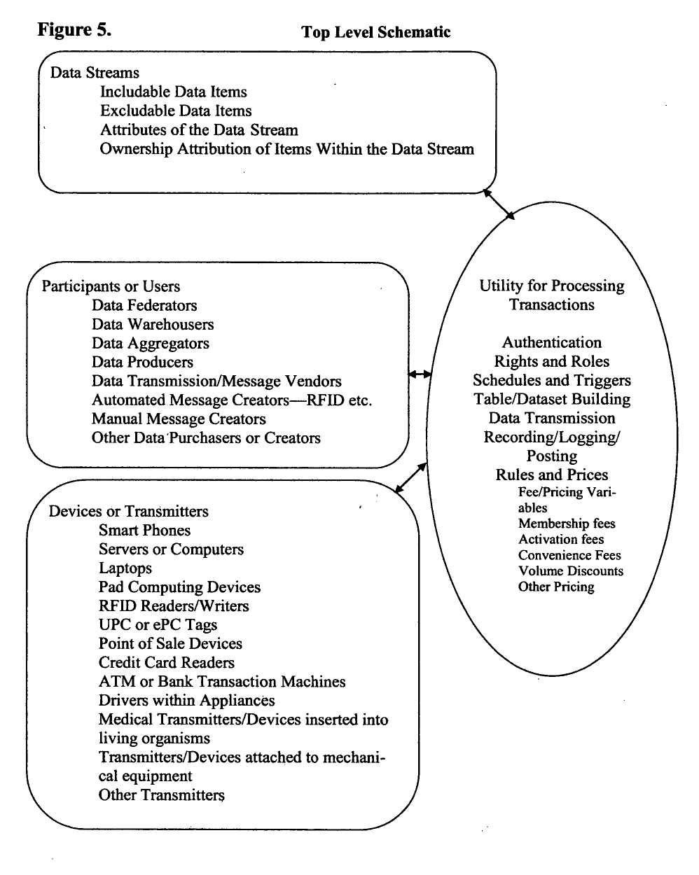

### DETAILED DESCRIPTION OF THE INVENTION

Digital content contained within a messages or housed on an RFID or other electronically readable data tag or transmitted by an electronic device will be referred to as a “data stream.” Values and prices for one or a plurality of data fields extracted from a data stream may increase or decrease depending upon many variables. Smith (Ser. No. 12/930,280) teaches at least one variable for pricing data, but does not specifically present a system or method to enable pricing for writing or reading information, for a stream of characters or data within a digital message or a set of data items posted onto or captured from an RFID or other electronically readable data tags or transmitters. This includes the many variants of miniaturized data transmitters that use the merging capability of nanotechnology and other data transmission technology to exchange data through wireless and electronic means. The invention described herein identifies potential linkages among one or a plurality electronically readable data tags and data streams and strings of digital content within messages. Manufacturers and producers of products or commodities, logistics managers, transporters, vendors, financial institutions, participants in product or commodity supply chains associated with one or a plurality of electronically readable data tags, and senders and receivers of messages through the Internet or through wireless satellite linkages from electronic devices capable of implementing computer readable code can all benefit from the systematic pricing of data and the processing of data and systems and methods for exchanging and acting upon that data in real time. Medical providers can similarly access and leverage data streams from devices implanted or attached to or co-located with living biological entities that transmit status information and updates about chemical and biological processes in real time.

Embodiments of the patent described herein focus on the implementation of pricing schemata for data items written to or extracted from one or a plurality of electronically readable data tags or data streams contained in electronic messages further associated with:
1. each type of participant in a supply chain of goods and services as well as a data supply chain
2. each data item or group or plurality of data items in a data stream
3. each linked business process or action resulting from events initiated by one or a plurality of users, where users are associated with the physical supply chain of the material or product or commodity or service and the digital data supply chain and the subsets of data associated with electronically readable data tags or digital messages or data streams produced by devices capable of implementing computer readable code.

Art beginning with Smith (U.S. Pat. No. 7,860,760) and continuing through Smith's additional patent applications (Ser. No. 12/930,280), (Ser. No. 12/932,79), (Ser. No. 12/932,798), (Ser. No. 13/134,59), and (Ser. No. 13/135,420) has begun to shape and outline parameters for a workable market for data trading. U.S. Pat. No. 7,860,760 introduces art regarding the association of a data item with a price for a data item extracted from one or a plurality of data sources and linked together into chains to be subjected to evaluation by a formula to trigger notifications and other server actions through electronic devices capable of implementing computer readable code. This art bypasses the need to download entire datasets (though that remains an option) and focuses on the data field/item or groups of data items as the unit for transactions and operations. In effect, the art covers cases when one or a plurality of data items is extracted from a data source or a data stream and posted into a trigger or threshold formula and a price is charged for extracting the one or a plurality of data items and for linking the data item into other data sources or datasets. Options for charging fees are flexible; for the data item or items themselves, for linking data items to datasets, for using a utility to create and price data tables from data streams, and for using data items to trigger server actions.

Patent Ser. No. 12/930,280 introduces art to use search engines to locate data sources with potential value to a participant in a data supply chain through networks of electronic devices capable of implementing computer readable code, the Internet, or other linked electronic devices, and to price the one or a plurality of data items within the located data source or the data source itself by popularity or other criteria. Additional art introduced by Ser. No. 12/930,280 is a method for a “handshake” between a buyer and a seller of data if one or a plurality of data items data streams or data sources are discovered through a search across electronic devices. The art describes a method and system to further act upon the one or a plurality of data items data streams or data sources to initiate transfer of the one or a plurality of data items, and to implement pricing and collection of fees for the one or a plurality of data items. The system and method described herein for reading or writing data from an electronically readable data tag or an electronic message or a data stream from a device capable of implementing computer readable code, such as an SMS text message or a Twitter or Microsoft Instant message or a stream of pixels (or indeed any other form of digital data) in a data stream in order to generate a fee or price for that data continues the art in Ser. No. 12/930,280.

Patent Ser. No. 12/932,797 is a further continuation of Ser. No. 12/930,280 through introduction of art to track user interaction with a GUI to adjust prices and fees for processing data obtained through the implementation of systems and methods described above. It introduces a method and system to count the number of interactions with the GUI and adjust pricing based upon the volume and type of interaction with the GUI. In similar fashion, some of the art of the patent described herein tracks and counts interactions with one or a plurality of electronically readable data tags or data streams within a message or data streams from an electronic device capable of implementing computer readable code where interactions among various components of the system similarly can be included in the pricing schema for data read from the one or a plurality of electronically readable data tags or message streams or other data streams. Pricing the processing and manipulation of data streams through use of computer readable code interacting with a GUI is specified in the patent described herein to apply to data steams from electronically readable data tags and from messages exchanged through instant messaging applications, SMS text messaging applications, or other messaging applications as well as digital data from any electronic device capable of implementing computer readable code.

Patent Ser. No. 12/932,798 also continues art in Ser. No. 12/930,280 and introduces art to enable adjustment of the price or fee for a data item based on the weight or reputation of the source of an observation about a data point as well as enabling adjustments to the value or price for a data item based upon the importance or value assigned to the item by one or a plurality of recipients of the data, where the recipient may be a human being or an electronic device capable of implementing computer readable code. The art enables a price adjustment for one or a plurality of sources and one or a plurality of target domains or topics of data items. The system and method described herein extends this art to data items read from or written to electronically readable data tags or derived from data streamed or contained within a message implemented through computer readable code and transmitted across electronic devices or generated by electronic devices capable of implementing computer readable code.

Patent Ser. No. 13/134,596 also continues Ser. No. 12/930,280 by introducing art to address transfers of data streams generated by, within, or through use of mobile or remote devices such as GPS location data, data created and input by users of social media applications such as Facebook and Twitter, data generated by point of sale devices, and other data that vendors of Internet accessible services may generate through user interactions with implementations of their services as well as data created through computer readable code that implements their services. If any data is owned by the owner of a device that generates it or by the human being that creates it, Ser. No. 13/134,596 addresses use of keys or codes by buyers and sellers of data to automate exchanges of fees concurrent with or separate from data uploads and downloads. The art of Ser. No. 13/134,596 introduces a method and system to manage the intersection of data and electronic devices with data aggregators, data brokers, or data federators. In effect, Ser. No. 13/134,596 describes art for automatic uploading of data housed upon, transmitted through, and/or generated by distributed electronic devices, the authentication of ownership of the data, and resulting fund transfers. The art of Ser. No. 13/134,596 is explicitly extended and expanded from electronic devices capable of implementing computer readable code to electronically readable and writeable tags and biological diagnostic or status implants or transmitters or diagnostic or status transmitters attached to mechanical or physical entities through the invention described herein. The art is also explicitly extended and expanded to messages and strings of data transmitted electronically over the Internet or other linked electronic devices.

Further art developed by Smith (Ser. No. 13/135,420) enables data collected and formatted through electronic devices with value to a data warehouse, data federator, data aggregator, or a researcher to be formatted to facilitate the sale or redistribution or reassignment of the data by enabling it to conform to requirements of a prospective purchaser. Smith's (Ser. No. 13/135,420) invention defines a Data Item Pair or DIP as a unit containing both a “question” and an “answer” and is particularly useful for survey research or research into specific arenas where the requirement is less for data mining and more for data to post directly into analytic engines. One embodiment of this invention implements the art of Smith (Ser. No. 13/135,420) to shape and define the data items within a data stream into Data Item Pairs as an initial step prior to writing the data to an electronically readable data tag or any other data stream to explicitly expand the art of Smith (Ser. No. 13/135,420). Other embodiments of Smith (Ser. No. 13/135,420) use common data item formats readily convertible to CSV files, XML files, or other formats for data strings.

A typical embodiment of the invention described herein enables a data warehouse, federator, aggregator, broker, reseller, researcher, or consumer to specify one or a plurality of digital strings of data from an electronically readable data tag or from a message or from an electronic device capable of implementing computer readable code containing one or a plurality of data items to be transferred to another electronic device or uploaded to one or a plurality of devices through the Internet or networks of connected wireless or hard wired electronic devices and to provide templates and instructions for manual formatting or to provide computer readable code, often called a “utility,” to enable the seller to price and format or transform the data stream according to the buyer's or the seller's specifications. Expanding upon the concept of the “utility” is the capacity provided by HTML5 and other emerging computer coding languages to embed and enable API's within web pages so that transformations of data streams can be more readily accomplished. Implementation of API's through HTML5 and Python will blur the distinction between a “data stream,” a “dataset” and a “database” when digital information is transmitted through the Internet.

Another embodiment of the invention described herein enables a user, where the user is a human being or a device capable of implementing computer readable code to convert a string of data within a message into a format for posting to an electronically readable data tag, and to implement a fee for the conversion or the posting of the data to the tag. The definition of a “tag” in the invention described herein is any entity embedded into or attached to any other entity with a capability of storing digital information readable or receivable by any electronic device, whether through active transmission of digital information or enabling access for reading by en electronic device.

Another embodiment of the invention described herein enables a user, where the user is a human being or a device capable of implementing computer readable code to convert a string of data within an electronically readable data tag into a format for posting into a message, such as a Twitter message or an SMS message and to implement a fee for the conversion and a fee for posting the data.

Another embodiment of the invention described herein enables a user, where the user is a human being or a device capable of implementing computer readable code to convert a string of data captured or read from an electronic device capable of implementing computer readable code into an alternate format for posting into a second or a plurality of electronic devices capable of implementing computer readable code and to implement a fee for the conversion and a fee for posting the data.

Another embodiment of the invention described herein enables a user to implement a price of fee for conversion of a data stream or a string of data extracted from an electronically readable data tag associated with a material entity or a miniaturized data transmission device that may be placed into or attached to a living being to update changes in status or performance of biological or chemical or other systems of the living being or material entity, thus alerting providers of medical or reparative services to transmit and evaluate the information to enable restorative medical or other actions to redress imbalances or needs indicated through interpretation of the data.

Another embodiment of the invention may expand upon the capability described immediately above by transforming messages transmitted through an Internet message server or service, such as Twitter, into sets of Data Item Pairs as explicated in patent application (Ser. No. 13/135,420) for well-formed posting of data into analytic engines where questions and answers are the pivotal concern, rather than data mining, and to implement a fee for the conversion and a fee for posting the data.

The method and system for pricing exchange and conversion of data from one or a plurality of data streams from electronically readable data tags or data within digital messages or data generated by electronic devices capable of implementing computer readable code can intersect with a tag reading or writing electronic device or across electronic devices such as “smart phones” or “tablets” capable of implementing computer readable code or SMS or other formats of digital messages from messaging services such as Twitter or Microsoft IM or other messaging vendors; the data including a unique digital identifier for items associated with a supply chain, status information for items, and descriptions and other attributes associated with the items. Also included is information regarding the pricing of the data items by the item, pricing for processing the data items, and information identifying an association with at least one user who will pay all or a portion of a fee charged for the data.

Data streams will be translated into formats suitable for writing to an electronically readable data tag or into a message or onto a device capable of implementing computer readable code directly or through intermediate devices such as tag writers or smart phones. If a graphical user interface from one or a plurality of messaging services is invoked, a data stream can be posted through the graphical user interface by a human being or by computer readable code on one of the associated devices.

When data is converted or posted or processed, an alert is generated for users of the system described herein of the fee or plurality of fees to be charged for processing the transaction or for the data items themselves, and a record of the exchange and the fees and prices and charges is created and retained and stored along with time stamps synchronized to a single time standard. Associated with the alerts and records is a set of relationship vectors or a series of hierarchies indicating relationships among items, data tags, messages, and other data streams and intersections of these with prices, fees, or charges. As is common in business, it is expected that updating pricing for data transfer and other information will be done routinely; in one embodiment, through sensors housed on electronically readable data tags associated with items, or through collecting a count of message streams and updating pricing for transfer of data items contained within them and other information, or through use of an electronic device capable of implementing computer readable code. The system and method will convert data streams into formats readable and usable by electronically readable data tags, messaging services, telemetry sensors, and other electronic devices capable of implementing computer readable code and will also retain updated records and histories of transactions. As updates are done, alerts to devices and human beings linked into the system will be generated according to rules associated with alerts as well as other actions within devices or services associated with the data items, data streams, or other components of the system.

Transactional records will contain and retain copies of the data streams themselves in their original form as well as in their transformed or converted formats to enable receipt of queries and responses to queries concerning the status of an item or a set of associated or related items associated with data stored on electronically readable data tags or within message streams or upon electronic devices capable of implementing computer readable code. Transactional records will also include prices and fees and charges for exchanges or transfers of the data items or the data streams along with records of alerts that have been sent and the devices or persons who received the alerts.

Smith (U.S. Pat. No. 7,860,760) describes art to trigger and generate actions upon events or changes in the status of a data item. The method and system described in Smith (U.S. Pat. No. 7,860,760) will be available to address or respond to changes in the data streams included and explicated in the invention described herein. In addition, the detection of the presence of data stored on one or a plurality of electronically readable data tags or message streams proximal to one or a plurality of electronic devices capable of transmitting data to one or a plurality of electronically readable data tags or electronic devices after an alert condition is recognized will initiate transmission or writing and posting of updated data to electronically readable data tags or to electronic devices capable of receiving wireless transmission of data upon detecting the presence of electronically readable data tags or electronic devices and confirming copying and posting authority. Further, the detection within the electronic device includes implementing rules to evaluate the data transmitted or posted prior to or following posting or updating triggered by alert conditions to determine or generate further actions by the electronic device, including further writing of updated data to electronically readable data tags or into graphical user interfaces provided by vendors of systems for input into messages to be sent through massaging services or programs. These processes can also be initiated upon detection of a sensor or radio frequency transponder associated with an electronic device or an electronically readable data tag.

An embodiment of the invention described herein will provide and implement a data processing environment accessible to users participating in a data supply chain to provide users with real-time visibility and updates of the disposition of items by posting or providing access to data stored on electronically readable data tags that use radio frequency identification protocols and may include electronic product codes or other product coding as unique identifiers within the tag. Also included in this embodiment are data streams within messages from messaging services and data streams generated by or within electronic devices. Users of the invention may be offered one or a plurality of options for fees and prices. In every embodiment of the invention described herein, multiple configurations for pricing and fees are an option dependent upon the business method and the marketing need or strategy for the producers and consumers of the digital data. One option is to join a research consortium and pay a membership fee for rights to data within that consortium. Another option is to pay an activation fee for the right to use the tools for data access, conversion, posting and other operations. Another option is to pay a subscription fee for access to one or a plurality of the components associated with the invention. Also available within the various pricing schemata are discounts for volumes of traded or exchanged data streams and “convenience” fees for ready access to data transfer kiosks or other services or processes enabled through devices or computer readable code to leverage the advantage inherent in the timeliness of data exchanges.

An embodiment of the system and method also includes computer readable code to instruct connected electronic devices to transmit, record, post, and link credit card data associated with radio frequency identification (RFID) electronically readable data tags and read from the tags by a credit card reading device or other electronic devices serving as a credit card reader;
information about the bank or financial institutions or person or entities that will receive the data,
instructions regarding the confidentiality data items on the electronically readable data tag,
identification of which data items are transmissible,
and the price to charge the institution or entity or person for the transmitted data.

Embodiments of the invention described herein that are not directly linked to electronically readable data tags, but to messages and other data streams will also arrange and implement the transmission, recording, posting, notifications of fees, and exchange of fees for the data contained in the data streams or the data streams themselves as described in the preceding paragraph. In these embodiments, authorization information will be associated with the data streams in accordance with the practices and methods and procedures of the messaging services or the methods and practices and procedures of the current owners and producers of the data and the data streams containing the data. Determinations of visibility of data and access to data or ability to change or alter data will be made and implemented according to rule sets established by current owners of the data. It is expected that this information regarding authorization and visibility may be linked directly or indirectly to the system and method described herein. It is further expected that the methods and procedures for implementing payment of fees and recording of financial and other transactions can be implemented through intermediary systems and processes and devices that are either directly linked or indirectly linked to the components of the system of the patent described herein.

Electronic devices that run computer readable code to implement the system, method, and procedures of the invention described herein may be loosely confederated or housed within a single processor or distributed across networked computing and database environments. The method and system may also be distributed and implemented through linked sensors or sets of sensors. Actions and concatenating processes and procedures such as creating records and logs and initiating server actions or events can be implemented in some embodiments through linked datasets and linked devices in many configurations. However, for the system to operate effectively, processing and disposition information must include item attributes and authorization information specifying a user to which an item attribute can be made visible for at least one item.

In most embodiments the data is furnished in real time and computer readable code implements the system and method through an information carrier. Computer readable code embodied in an information carrier can instruct one or a set of connected electronic devices to record exchange or transfer data among electronic devices of one or more users with the code instructing an electronic device to process rules specifying pricing data and other data to furnish to associated electronic devices. Additionally, in some applications in the homeland security or medical arenas, the focus may not be on pricing, but on the exchange and crediting processing that are derived from considerations related to pricing. In these instances, the cross agency and cross research links will still be enabled through a credit and debit process for attribution of data origination, even though fees themselves may not be exchanged.

In some embodiments, attributes of the data or the data type itself may need to be adjusted locally in some fashion to make a match precise with other data streams. This may be done manually or through implementing computer readable code or a utility to transform the data items or the data stream itself. An exchange enabling confirmation of pricing can then proceed and the exchange of data items or data streams structured and implemented. It is the data stream or string or the data items within the strings that are the units to be evaluated and priced.

An example of an embodiment of the invention described herein uses a utility of computer readable code to convert a data stream into a tabular format by posting a graphical user interface onto an electronic device accessible to one or a plurality of users of the invention authorized to have access to the utility. The utility implements computer readable code to discover information associated with the data stream, such as; the originating user, the source originating device or RFID or electronically readable data tag or the messaging service transmitting the data stream, or the vendor of the data stream, or the target recipient of the data stream, or the target device receiving the data stream, or any of a combination of these variables or other variables consistently associated with a data stream. A few other variables consistently associated with a data stream may be the type of device transmitting the data stream, the IP address of the device, the format or sequence of transmission ID codes associated with the data stream, and other identifying characteristics of the data stream. Also available through the graphical user interface of the utility running computer readable code is the ability of an authorized recipient of at least one data stream to open the data stream to review the pattern of the data being transmitted and to designate one or a plurality of portions of a data stream viewable through the graphical user interface to be assigned to one or a plurality of row labels, one or a plurality of portions of the data stream to be assigned to one or a plurality of column labels, and one or a plurality of portions of the data stream to delete from the stream prior to posting the data into a table. The authorized user of the utility may create or select row and/or column labels drawn from lists within the utility or generated by computer readable code within the utility. In most instances of the use of the utility, the segment of a single data item or a set of data items within the data stream in a specific position within the data stream will be sufficient to identify it and tag it for a row or a column assignment. However, data type and data mask or other variables commonly used for data allocation or grouping may also be included as conditional criteria for assignment to a row or a column within the utility. The utility may have many options or be quite limited in its set of options and choices dependent upon the variability of the data streams to be subjected to evaluation and configuration for conversion into a tabular format. An authorized user may save the template or configuration for managing one data stream and may instruct the device housing the utility or enable an authorized user to implement an automated process using computer readable code to apply the configuration to all data streams from the same originator or data streams sharing the same characteristics and attributes. An alternative embodiment enables an algorithm to be used to structure the data through implementation of computer readable code in a fashion similar to the manual building of one or a plurality of sets of rules for processing a data stream as described above.

In both embodiments immediately above, the additional advantage of a utility or algorithm is the option to implement authentication and validation routines to regulate the visibility of data items within the data stream and to authorize posting of data items within the data stream into tables or other structured data formats. An additional advantage is the ability to build a record of the number of uses of the utility and the number of data fields assigned to columns or rows and to include into a calculation formula for pricing the use of the utility itself as well as the number of data items posted into rows and/or columns.

Many other embodiments are possible for one skilled in the art to evolve. The drawings and the explanation above are intended to be illustrative of options for alternative embodiments, and are not intended to be exclusive or exhaustive.

1. A method and system for pricing exchange and/or conversion of data from one or a plurality of data streams from electronically readable data tags or data transmitters or diagnostic devices associated with living beings or mechanical systems or data within digital messages, or data generated by electronic devices capable of implementing computer readable code comprising:
using a reading and/or writing electronic device to read multiple instances of data from one or a plurality of electronically readable and/or writable tags containing data associated with one or a plurality of items, including a unique digital identifier for the one or a plurality of items, also including status information for the one or a plurality of items, including descriptions and other attributes associated with the one or a plurality of items, including prices and charges for the reading and transmission of the data associated with the one or a plurality of physical items or services, including pricing for one or a plurality of data items, and including pricing for processing the one or a plurality of data items;
using a reading and/or writing electronic device to read multiple instances of data from one or a plurality of electronically readable and/or writable data transmitters storing or generating data associated with one or a plurality of physical or mechanical entities, one or a plurality of living beings, or one or a plurality of other devices, including a unique digital identifier for the one or a plurality of living beings or physical or mechanical or other devices, also including status information for the one or a plurality of living beings or physical or mechanical or other devices, including descriptions and other attributes associated with the one or a plurality of living beings or mechanical or other devices, including prices and charges for the reading and transmission of the data associated with the one or a plurality of biological or mechanical systems, including pricing for one or a plurality of data items, and including pricing for processing the one or a plurality of data items;
deriving from a message stream from a messaging provider such as Twitter one or a plurality of data items, including a unique digital identifier for the one or a plurality of data items, including descriptions and other attributes associated with the one or a plurality of data items, including pricing for the one or a plurality of data items, and including pricing for processing one or a plurality of data items;
receiving from one or a plurality of users, where a user is a human being or an electronic device capable of running computer readable code, one or a plurality of fees to charge for processing the data on the one or a plurality of electronically readable data transmitters or tags or in the one or a plurality of messages or in the one or a plurality of electronic devices, one or a plurality of attributes of the one or a plurality of data items, one of the attributes identifying an association with at least one or a plurality of users who will respectively pay all or a portion of a fee charged for data associated with one or a plurality of electronically readable data transmitters or tags or data steams contained within a message, one or a plurality of attributes indicating one or a plurality of data sources on one or a plurality of electronic devices to accept one or a plurality of postings of data from the one or a plurality of electronically readable data transmitters or tags or data streams contained within a message, and one of the attributes indicating a date and time stamp for the processing of the data from the one or a plurality of electronically readable data tags or data contained in a message stream or within an electronic device capable of implementing computer readable code.

2. The method of claim 1, further comprising converting a data stream within a message sent through a messaging service such as Twitter using an electronic device capable of implementing computer readable code;
translating the data stream into a format suitable for writing directly to an electronically readable data tag;
and posting onto an electronic device capable of writing to an electronically readable data tag or posting a data stream directly upon an electronically readable data tag.

3. The method of claim 1, further comprising converting a data stream from an electronically readable data tag or transmitter through an electronic device capable of implementing computer readable code;
translating the data stream into a format suitable for posting onto an electronic device capable of implementing computer readable code;
posting the data stream directly onto an electronic device directly or through a device capable of writing to an intermediate device capable of implementing computer readable code;
invoking a graphical user interface from one or a plurality of messaging services;
and posting the data stream from an electronic device or messaging service or directly from an electronically readable data tag or transmitter.

4. The method of claim 1, further comprising generating an alert for one or a plurality of users obliged to pay a transaction fee for exchanging data stored on one or a plurality of electronically readable data tags or within one or a plurality of message streams on one or a plurality of servers associated with one or a plurality of vendors of messaging services such as Twitter messages or SMS messages, where a user is a human being or an electronic device capable of running computer readable code.

5. The method of claim 1, further comprising: maintaining a record of the most recently exchanged data stored on one or a plurality of electronically readable data tags or transmitters or contained within one or a plurality of message streams from one or a plurality of messaging services or from one or a plurality of electronic devices and pricing information associated with the exchange of the data.

6. The method of claim 1, further comprising associating time stamps synchronized to a single time standard with each exchange or update of data stored on one or a plurality of electronically readable data tags or transmitters or one or a plurality of data items contained in one or a plurality of message streams from one or a plurality of messaging services or from one or a plurality of electronic devices.

7. The method of claim 1, further comprising exchanging one or a plurality of hierarchies of relationships among items associated with data stored on an electronic device or on one or a plurality of electronically readable data tags or transmitters or contained within one or a plurality of message streams from one or a plurality of messaging services or from one or a plurality of electronic devices.

8. The method of claim 1, wherein at least one of the hierarchies of relationships indicates prices and fees for exchanging information about one or a plurality of items associated with one or a plurality of other items on an electronic device or on one or a plurality of electronically readable data tags or contained within a stream of data in a message sent exchanged through one or a plurality of electronic devices.

9. The method of claim 1, further comprising updating pricing for data transfer and other information with data posted through a sensor housed on one or a plurality of electronically readable data tags or transmitters associated with one or a plurality of items, through collecting a count of message streams and updating pricing for transfer of data items contained within one or a plurality of messages, or through collecting a count of data streams and updating pricing for transfer of data items contained within one or a plurality of data streams from electronic devices capable of implementing computer readable code.

10. The method of claim 1, further comprising updating pricing for data transfer and other information with data obtained from one or a plurality of external electronic devices or transmitters or systems associated with one or a plurality of electronically readable data tags or transmitters or message streams from one or a plurality of messaging services or from one or a plurality of electronic devices.

11. The method of claim 1, further comprising updating pricing for data transfer and other information with data obtained through telemetry from a sensor associated with a particular location, with one or a plurality of users, with one or a plurality of electronic devices, and with one or a plurality of electronically readable data tags or transmitters or message streams from one or a plurality of messaging services or from one or a plurality of electronic devices.

12. The method of claim 1, further comprising generating an alert upon updating data on an electronically readable data tag or transmitter for one or a plurality of users, where a user is a human being or an electronic device capable of running computer readable code.

13. The method of claim 1, further comprising attaching one or a plurality of rules to an item, the one or a plurality of rules triggering alert events or causing other actions implemented through computer readable code on electronic devices associated through the method and system of the invention.

14. The method of claim 1, further comprising receiving, processing, and responding to a query concerning the status of an item associated with data stored on or in one or a plurality of electronically readable data tags or transmitters or message streams from one or a plurality of messaging services or from one or a plurality of electronic devices.

15. The method of claim 1, further comprising receiving, processing, and responding to a query concerning the status of an item associated with data stored on one or a plurality of electronically readable data tags or transmitters or within message streams or upon electronic devices capable of implementing computer readable code.

16. The method and system of claim 1, including pricing and fees for processing writeable information stored on one or a plurality of electronically readable data tags or transmitters or data streams associated with one or a plurality of items or entities, the method comprising,
receiving into a system pricing or fees or charges for exchanging data derived from data read from a tag or transmitter or from a data stream connected or associated with the one or a plurality of items or entities;
maintaining in the system a record of the pricing and fees and charges for exchanging data;
recognizing an alert condition from data provided by the one or a plurality of users, the alert condition relating to the one or a plurality of the items or entities;
generating updated data to be written to the one or a plurality of designated items in response to the alert condition;
detecting in the system the presence of data stored on one or a plurality of electronically readable data tags or transmitters or electronic devices proximal to one or a plurality of electronic devices capable of transmitting data to one or a plurality of electronically readable data tags or transmitters or associated electronic devices after the alert condition is recognized;
and causing the one or a plurality of electronic devices capable of transmitting data to write updated data to the one or a plurality of electronically readable data tags or transmitters or electronic devices and enabling initiation of a message through computer readable code interacting with a graphical user interface of a messaging service upon detecting the presence of the one or a plurality of electronically readable data tags or transmitters or associated electronic devices.

17. The method and system of claim 16, wherein the alert condition associated with pricing information is recognized through computer readable code running on one or a plurality of electronic devices, the one or a plurality of electronic devices receiving data from the one or a plurality of electronically readable data tags or transmitters or electronic devices housing data for the one or a plurality of items or entities associated with the system;
posting updated data provided through computer readable code on the one or a plurality of electronic devices with a request that updated data be written to the one or a plurality of electronically readable data tags or transmitters into a graphical user interface associated with an electronic messaging service or vendor or device associated with one or a plurality of items or entities;
and writing updated pricing and associated data to the one or a plurality of electronically readable data tags or transmitters or electronic devices linked to a graphical user interface for one or a plurality of messaging services or vendors.

18. The method and system of claim 16, wherein the alert condition is recognized by a component of the system operating in accordance with one or more alert rules provided to the system;
generating updated data through a component of the system operating in accordance with one or more update rules provided to the system;
writing updated data to the first or a succession of tags or transmitters in accordance with one or more read-write data rules provided to the system.

19. The method and system of claim 16, wherein a sensor is connected to the one or a plurality of electronically readable data tags or transmitters or electronic devices linked to a graphical user interface for one or a plurality of messaging services or vendors.

20. The method and system of claim 16, wherein the one or a plurality of electronically readable data tags or transmitters is a radio frequency transponder.

21. The system of claim 1, wherein a data processing environment is implemented including one or a plurality of users participating in a data supply chain;
providing users with real-time visibility of the disposition of items in the data supply chain by posting or providing access to multiple instances of readable data stored on one or a plurality of electronically readable data tags or transmitters connected to one or a plurality of items, the data and information read including a unique tag identifier and other data coded onto the tag;
using the readable data received from one or a plurality of electronically readable data tags to maintain disposition information for the items;
receiving from one or a plurality of users multiple instances of readable data stored on one or a plurality of electronically readable data tags or transmitters, each instance including information read from a tag or transmitter connected to an item or entity, the information read including a unique tag identifier among other information coded onto the tag;
using the data read from the tag or transmitter to maintain information for the items or entities, where readable data stored on one or a plurality of electronically readable data tags or transmitters from a user for a particular item or entity is used to update information;
and making updated information visible to the one or a plurality of authorized users in the data supply chain upon electronic devices associated with data supply chain.

22. The system and method of claim 21, wherein the electronically readable data tags or transmitters or electronic devices using radio frequencies connected to the items or entities link to radio frequency identification (RFID) electronically readable data tags or message streams, each RFID tag carrying an electronic product code (ePC) or other product coding and identification convention as one of the unique tag identifiers.

23. The system and method of claim 21, wherein computer readable code instructs one or a plurality of connected electronic devices to record, post, and link credit card data associated with one or a plurality of radio frequency identification (RFID) electronically readable data tags or associated electronic devices connected to the one or a plurality of items, each RFID tag carrying an electronic product code (ePC) or other product coding and identification convention as one of the unique tag identifiers.
accepting from an electronic device serving as a credit card reader an indication of the bank or financial institution that will receive the data;
accepting from the electronically readable data tag or transmitter instructions regarding the confidentiality of one or a plurality of data items on the electronically readable data tag or transmitter;
posting from the electronically readable data tag or transmitter the one or a plurality of data items that are marked as transmissible to the one or a plurality of financial institutions or entities;
posting from the electronically readable data tag or transmitter the price to charge the one or a plurality of entities receiving the one or a plurality of data items respectively;
transmitting the one or a plurality of data items that are marked as transmissible to the one or a plurality of financial institutions or entities;
and transmitting the price to charge the one or a plurality of entities receiving the one or a plurality of data items respectively.

24. The system and method of claim 21, wherein computer readable code instructs one or a plurality of connected electronic devices to record, post, and link credit card data associated with one or a plurality of radio frequency identification (RFID) electronically readable data tags or transmitters or electronic devices connected to the one or a plurality of items, each RFID tag or transmitter carrying an electronic product code (ePC) or other product coding and identification convention as one of the unique tag identifiers.
accepting from an electronic device serving as a credit card reader an indication of the bank or financial institution that will receive the data;
accepting from the electronically readable data tag or transmitter instructions regarding the ownership of one or a plurality of data items on the electronically readable data tag or transmitter;
posting from the electronically readable data tag or transmitter the one or a plurality of data items that are marked as owned by the one or a plurality of entities associated with the electronically readable data tag or transmitter respectively;
posting from the electronically readable data tag or transmitter the price to pay the one or a plurality of entities upon receiving the one or a plurality of data items respectively;
transmitting the one or a plurality of fees for the one or a plurality of data items transmitted to the one or a plurality of owners of the one or a plurality of data items respectively;
and transmitting from the one or a plurality of financial or payment entities the one or a plurality of payments for the one or a plurality of data items transmitted to the one or a plurality of owners of the one or a plurality of data items respectively.

25. The method of claim 21, wherein visibility is controlled through receipt of authorization information indicating the extent to which the information should be made visible to a particular user within the data supply chain;
and making visible to the particular user only the information which is permitted by the authorization information.

26. The method of claim 21, wherein a record is generated of one or a plurality of electronic devices sending authorization information and uploading or posting data visible to one or a plurality of users within the data supply chain;
implementing computer readable code to associate a fee or charge with the record visible to the one or a plurality of users permitted by the authorization information;
initiating an electronic payment or exchange process through computer readable code on the one or a plurality of electronic devices associated with the data supply chain;
and recording the payments and fees exchanged through implementation of the computer readable code on the one or a plurality of electronic devices associated with the data supply chain.

27. The method of claim 23, wherein the disposition information includes a plurality of item attributes; and the authorization information specifies, for at least one item attribute, the user to which the item attribute can be made visible.

28. The method of claim 26, wherein the data is furnished in real time.

29. The system and method of claim 1, wherein computer readable code implements the system and method and is embodied in an information carrier.

30. The system and method of claim 1, wherein computer readable code updates information on a writable tag connected to one or a plurality of items, the computer readable code enabling an electronic device to post attribute and pricing and fees and charges for processing data connected to a first item, where the data is read automatically from data stored on one or a plurality of electronically readable data tags or is within one or a plurality of message streams received from one or a plurality of messaging vendors or services or is associated with a sensor connected to the first item or a series of items respectively;
exchanging through the system sensor information derived from data read automatically from a sensor coupled to one or a plurality of items respectively;
exchanging through the system sensor information specifying a relationship between the one or a plurality of items respectively;
writing a record of information representing attribute information and sensor information for one or a plurality of items respectively;
maintaining within the system a record representing the relationship between the one or a plurality of items;
recognizing an alert condition from information on the writable tag or within the record maintained within the system, or the alert condition relating to one or a plurality of items;
generating updated attribute information to be written to the media connected to one or a plurality of items in response to the alert condition;
and detecting in the system the presence of one or a plurality of electronically readable data tags or sensors or electronic devices after an alert condition is noted to cause the electronic device to write the updated information to the one or a plurality of electronically readable data tags or sensors or to post into the Graphical User Interface provided by a digital messaging service or vendor respectively.

31. The system and method of claim 1, wherein computer readable code embodied in an information carrier instructs an electronic device to post real time status updates of the one or a plurality of items and the receipt of and processing of fees associated with the processing of computer readable information contained on one or a plurality of electronically readable data tags or transmitters one or a plurality of electronic devices or one or a plurality of message streams processed by a vendor or service managing digital messages connected to one or a plurality of items.

32. The system and method of claim 1, wherein computer readable code embodied in an information carrier instructs one or a plurality of connected electronic devices to record exchange or transfer data among electronic devices of one or a plurality of users, the computer readable code instructing an electronic device to process rules specifying what pricing data and other data to furnish to an external electronic device running computer readable code.

33. The system and method of claim 1, wherein computer readable code embodied in an electronic device enables one or a plurality of authorized users to implement computer readable code through a graphical user interface to instruct one or a plurality of connected electronic devices to select, transfer, and post data among electronic devices of one or a plurality of users, the computer readable code instructing an electronic device to store and process rules for opening a data stream within a message or an electronically readable data tag or transmitter or generated by an electronic device including;
selecting from a data stream one or a plurality of segments containing at least one data item within the data stream for one or a plurality of column inclusions;
selecting from a data stream one or a plurality of segments containing at least one data item within the data stream for one or a plurality of row inclusions;
selecting or entering a label into a table of row labels on a device authorized for access by the user one or a plurality of row labels to apply to the one or a plurality of data items within a data stream;
selecting or entering a label into a table of column labels on a device authorized for access by the user one or a plurality of column labels to apply to the one or a plurality of data items within a data stream;
specifying one or a plurality of row labels to apply to one or a plurality of data items within a data stream;
specifying one or a plurality of column labels to apply to one or a plurality of data items within a data stream;
building a record of the row labels and associated designated data items by one or a plurality of characteristics of data type, data format, mask, length, or other characteristic;
building a record of the row labels and associated designated data items by one or a plurality of characteristics of data type, data format, mask, length, or other characteristic;
posting the data items within the data stream according to the specification into a tabular structure;
implementing computer readable code to convert the specifications to a computer readable instruction set to be implemented upon devices included in the method and system of the invention to apply to data streams containing variables with identical characteristics or from identical data devices or messaging services or electronically readable identification tags or transmitters;
accepting pricing instructions and formulae for the one or a plurality of data items posted into a tabular structure;
accepting pricing instructions and formulae for the use of the computer readable code to build and retain the computer readable instruction set;
accepting pricing instructions and formulae for membership in a data sharing consortium;
accepting pricing instructions for an activation fee for use of the utilities and services associated with data exchange;
accepting convenience fee instructions for use of the utilities and services associated with data exchange;
accepting instructions for volume discounts for use of the utilities and services associated with data exchange;
accepting instructions for a subscription fee for use of the utilities and services associated with data exchange;
storing a record of pricing instructions and formulae for membership in a data sharing consortium;
storing a record of pricing instructions for an activation fee for use of the utilities and services associated with data exchange;
storing a record of convenience fee instructions for use of the utilities and services associated with data exchange;
storing instructions for a subscription fee for use of the utilities and services associated with data exchange;
storing a record of instructions for volume discounts for use of the utilities and services associated with data exchange;
implementing computer readable code to collect fees for membership in a data sharing consortium;
implementing computer readable code to collect fees for an activation fee for use of the utilities and services associated with data exchange;
implementing computer readable code to collect fees for convenience derived from use of the utilities and services associated with data exchange;
implementing computer readable code to collect fees for a subscription fee for use of the utilities and services associated with data exchange;
implementing computer readable code to refund or reduce fees for volume discounts for use of the utilities and services associated with data exchange;
storing the instruction set of row assignment, column assignment, and pricing formulae for data streams or portions of data streams or items within data streams on one or a plurality of electronic devices associated with at least one authorized user of the system and method of the invention;
initiating the instruction set upon receipt of a data stream from one or a plurality of authorized users or devices associated with electronic devices and data steams included in the method and system of the invention.
